(19) United States
(12) Patent Application Publication
(10) Pub. No.: US 2011/0225893 A1
(43) Pub. Date: Sep. 22, 2011

(54) FRAME ASSEMBLY AND PLASTIC PROFILE FRAME THEREFOR

(76) Inventors: Jörg Neukirchner, Erlangen (DE); Stefan Eckert, Forchheim (DE); Horst Tippenhauer, Marloffstein (DE); Markus Fischer, Furth (DE)

(21) Appl. No.: 12/673,518

(22) PCT Filed: Aug. 6, 2008
(86) PCT No.: PCT/EP08/06452

§ 371 Date: Feb. 15, 2010

(51) Int. Cl. E06B 3/22

(52) U.S. Cl. 49/504

(57) ABSTRACT

A frame assembly has a surface bearing element which comprises at least one glass pane. A plastic profile frame (1, 2) encloses the end face of the surface bearing element. For strengthening purposes, the plastic profile frame (1, 2) has reinforcing components (7, 14, 19, 26, 35) of fibre-reinforced plastic. A receiving portion (3) is provided as an enclosing edge portion of the surface bearing element. The reinforcing components (7, 14, 19, 26, 35) of fibre-reinforced plastic are boundary walls of internal hollow spaces (9-11, 16-18, 21-23, 28-30, 37, 38) which, together with non-reinforced boundary walls, bound the internal hollow spaces. The profile frame (1, 2) is embodied as a coextrudate of the reinforcing components (7, 14, 19, 26, 35) and the non-reinforced boundary walls (4, 5, 6, 12, 13, 25, 31, 32, 33, 34). This results in a frame assembly which can be produced using mass production techniques with minimal use of fibre-reinforced plastic material.

The invention relates to a frame assembly according to the preamble of claim 1 and to a plastic profile frame therefor. The invention further relates to a frame section for said profile frame.

A frame assembly of the above type is known from DE 82 02 221 U1. Another frame assembly comprising fiber-reinforced profile sections is known from DE 203 02 286 U1. A frame assembly comprising reinforcing components containing continuous fiber strips or fiber strands or designed as inserts in the form of rovings, mats or nettings is known from EP 1 245 775 A2. Reinforcement inserts constructed from fibers are also known from EP 0 902 148 A2 and WO 01/06079 A1.

The known fiber-reinforced frame assemblies are either not suited for mass production or else they require quite a high amount of fiber-reinforced plastic material.

Therefore, the object of the present invention is to improve upon a frame assembly of the type mentioned above in such a way that it can be manufactured using mass production techniques and using the least amount of fiber-reinforced plastic materials possible.

This object is accomplished according to the invention by a frame assembly with the features indicated in claim 1.

According to the invention, what was recognized is that the internal hollow spaces of the frame profiles can be delimited by fiber-reinforced reinforcing components only partially without causing loss of stiffness that can have an effect in practice compared to profile layouts in which the hollow spaces are completely delimited by fiber-reinforced materials. This results in a significant reduction in fiber-reinforced material compared to the prior art.

The approach according to the invention of delimiting only a portion of the hollow spaces with fiber-reinforced material also favors the layout of extrusion tools for purposes of coextrusion of such frame profiles since it is not necessary to extrude closed profiles made of un-reinforced material on one hand and those made of reinforced material on the other hand. By designing the reinforcing components so that they are exposed where they border the inner hollow spaces, material savings can be accomplished in the construction of frame profiles of frame components. In general, the reinforcing components must be covered on the visible sides of the frame profiles with un-reinforced plastic material of a certain layer thickness in order to ensure a pleasing surface structure of the visible walls of the frame profiles. In the design according to the invention, the wall thickness of a chamber wall of a frame profile is defined by the required thickness of the reinforcing component on the one hand and by the required thickness of a coating of un-reinforced plastic material on the visible side on the other hand. On the side of the reinforcing components facing the inner hollow spaces, further un-reinforced plastic material is unnecessary and is not added. Coextrusion manufacturing makes it possible to subdivide the cross section of the reinforced frame profiles practically arbitrarily, with fiber-reinforced wall sections on one side and un-reinforced wall sections on the other side. In the process, both the reinforcing components and the un-reinforced plastic components exist as a flowable extrudate. Thus, no pre-manufactured inserts are used, which for the most part are limited with regard to strip width of existing cross sectional shapes to flat or strip-like inserts. Also, complicated manufacturing of a continuous fiber-reinforcement such as is described in EP 1 245 775 A2, which in addition requires complete encasement of the reinforcing component with un-reinforced plastic material, can be eliminated.

An outer wall reinforcement according to claim 2 improves the strength of the frame assembly relative to wind loading.

In inner wall reinforcement according to claim 3 stiffens the frame assembly against forces acting against it from inside. What is preferred is for a profile frame to comprise both an outer wall reinforcement and an inner wall reinforcement since symmetry of thermal expansion behavior of the frame profile can be achieved, in particular. In the embodiments according to claims 2 and 3, a desirable larger distance between reinforcing components and the center of gravity of the profile is provided.

A reinforced folded fitting wall according to claim 4 stiffens the profile frame where it is required to absorb additional forces due to the installation of fittings.

A U-shaped cross section according to claim 5 provides the frame profile with particular stability. The U-shaped base contour can incorporate the entire frame profile, for example by extending over the inner wall, the outer wall and the folded fitting wall. Alternatively, the U-shaped base contour can be incorporated in only one part of a profile wall.

A reinforced inner wall according to claim 6, in other words, a wall that does not border the profile frame on the edge, provides the frame profile with stability where it is particularly required, for example due to static calculations.

A reinforced attachment wall according to claim 7 allows for good absorption of fastening forces by the frame assembly.

A reinforced seal seat according to claim 8 prevents undesired deformation of a seal seat.

A bent or angled shape of at least one reinforcing component according to claim 9 increases the stabilizing effect of the reinforcing component. Provided that absolute stability requirements are met, the reinforcing components can be manufactured with a reduction in the proportion of the cross section that comprises fiber-reinforced plastic extrudate.

Fiber lengths according to claim 10 have proven to be especially suitable for providing a coextrudable fiber-reinforced plastic component that forms a stabile reinforcing component after it cures.

The advantages of plastic profile frames according to claims 11 to 13 and of the frame profile according to claim 14 are the same as the advantages explained above with regard to frame assemblies according to claims 1 to 10.

Exemplary embodiments of the invention are explained below in more detail with the aid of the drawing. Shown are:

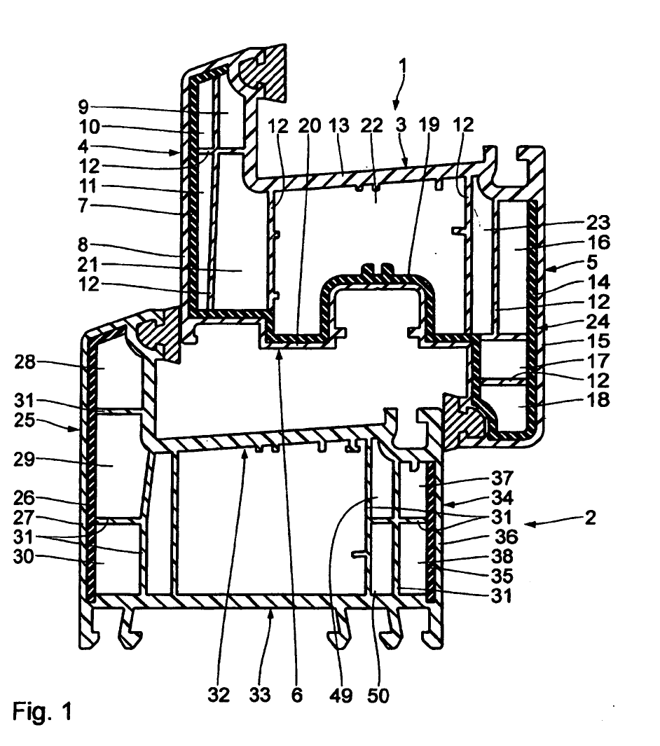

FIG. 1: A cross section through a sash frame profile and a window/door frame profile of a frame assembly for a surface bearing element to be framed with reinforcing components comprising fiber-reinforced plastic;

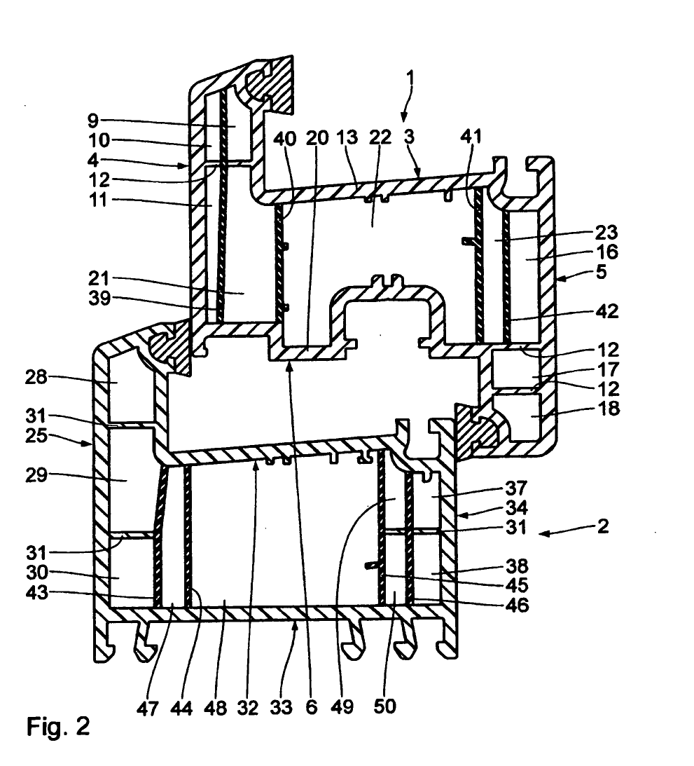

FIGS. 2 to 5 other embodiments of reinforcing components comprising fiber-reinforced plastic for sash and window/door frame profiles in a representation similar to FIG. 1.

In the cross sectional representations of FIG. 1 through 5, fiber-reinforced reinforcing components and reinforcing walls are identified using thicker hatch patterns to differentiate from other, unreinforced profile sections.

FIG. 1 shows a cross section of profile elements for a frame assembly for framing a surface bearing element, in particular a window or a door. Included in the frame assembly as peripheral plastic profile frames are a sash frame profile 1 and a window/door frame profile 2. An edge area of the surface bearing element, which is not shown, such as the edge area of a double glazing comprising two glass panes, is held in a rabbet base 3 of the sash frame profile 1. The rabbet base 3 represents a holding area for the peripheral edge section of the surface bearing element.

The sash frame profile 1 is designed as a hollow chamber profile comprising a plurality of hollow chambers. The hollow chamber design is identical in each of the profiles according to FIG. 1 through 5. The sash frame profile 1 comprises an outer wall 4, an inner wall 5 and a Folded fitting-wall 6 that connects the two walls 4, 5 together proximate to the window/door frame profile 2. An outer reinforcing component 7 of the sash frame profile 1 is embedded into the outer wall 4. The outer reinforcing component 7 provides a bracing for the frame assembly, in particular in the event of wind suction, i.e. a force direction toward the frame assembly from right to left in FIG. 1. This outer reinforcing component 7 follows the entire contour of the outer wall 4. The outer reinforcing component 7 is covered by an outer cover layer 8 toward the outside of the sash frame profile 1, said layer made of non fiber-reinforced plastic. The outer reinforcing component 7 represents a boundary wall for a total of three inner hollow spaces 9, 10, 11 of the sash frame profile 1. The outer reinforcing component 7 delimits the hollow spaces 9 through 11 together with un-reinforced, i.e. non fiber-reinforced, boundary walls 12 of the sash frame profile 1. A rabbet base wall 13 also represents such an un-reinforced boundary wall.

Where the outer reinforcing component 7 delimits the hollow spaces 9 through 11, it is uncovered as seen from the perspective of the hollow spaces 9 to 11. Thus it is not coated with un-reinforced plastic material, but rather is exposed. As such, not only does the outer reinforcing component 7 sit exposed, but all other reinforcing components described below in the exemplary embodiments lie exposed as well if they border hollow spaces.

Embedded into the inner wall 5 is an inner reinforcing component 14 of the sash frame profile 1, said component being bent in areas. The inner reinforcing component 14 acts in a bracing fashion, particularly against wind pressure, i.e. in a force direction from left to right in FIG. 1. In the process, the inner reinforcing component 14 essentially follows the inner wall 5. The inner reinforcing component 14 is covered toward the inside of the sash frame profile 1 by an inner cover layer 15 made of non fiber-reinforced plastic. The inner reinforcing component 14 represents a boundary wall for inside hollow spaces 16, 17 and 18 of the sash frame profile 1. These hollow spaces 16 through 18 are also delimited by the un-reinforced boundary walls 12.

A Folded fitting reinforcing component 19 is embedded into the folded fitting wall 6. This follows the entire contour of the folded fitting wall 6. The folded fitting reinforcing component 19 is covered by a folded fitting cover layer 20 that faces the folded fitting, i.e. the window/door frame profile 2, said cover made of non fiber-reinforced plastic.

The folded fitting reinforcing component 19 represents a boundary wall for inside hollow spaces 11, 17 and 18 and for hollow spaces 21, 22 and 23 of the sash frame profile 1. Hollow space 22 represents a central hollow space of the sash frame profile 1. In addition, hollow spaces 21 through 23 are also delimited by the un-reinforced boundary walls 12.

The three reinforcing components 7, 14 and 19 are combined to form an overall reinforcing component 24 of the sash frame profile 1, with an essentially U-shaped base contour as shown in the cross section in FIG. 1. In the process, the folded fitting reinforcing component 19 forms the base leg of the U and the inner reinforcing component 14 and the outer reinforcing component 7 form the lateral legs of the U.

In the cross section shown, the folded fitting reinforcing component 19 and the overall reinforcing component 24 are angled in areas and also bent in areas. This three-dimensional, non-planar configuration of the folded fitting reinforcing component and of the overall reinforcing component increases the stability thereof.

Embedded in an outer wall 25 of the window/door frame profile 2 is an outer reinforcing component 26 of the window/door frame profile 2. The outer reinforcing component 26 follows the entire contour of the outer wall 25. The outer reinforcing component 26 is covered toward the outside of the sash frame profiles 1 by an outer cover layer 27 made of non-reinforced plastic.
The outer reinforcing component 26 forms a boundary wall for outer hollow spaces 28, 29, 30 of the window/door frame profiles 2. Where the outer reinforcing component 26 delimits hollow space 28 on the inside is where the outer reinforcing component is angled. This increases the stability of the outer reinforcing component. Hollow spaces 28 through 30 are also delimited by un-reinforced boundary walls 31. A folded fitting wall 32 and an attachment wall 33, which faces a supporting brick structure (not shown) of the window/door frame profile 2, also represent such un-reinforced boundary walls.

Embedded in an inner wall 34 of the window/door frame profile 2 is an inner reinforcing component 35. The inner reinforcing component 35 is covered by the inside of an inner cover layer 36 made of non-reinforced plastic. The inner reinforcing component 35 represents a boundary wall for inner hollow spaces 37, 38 of the window/door frame profile 2. In addition, hollow spaces 37, 38 are also delimited by the un-reinforced boundary walls 31, 32 and 33.

All reinforcing components 7, 14, 19, 26 and 35 of the frame assembly according to FIG. 1 are made of fiber-reinforced plastic.

FIGS. 2 to 5 show further embodiments of sash and window/door frame profiles comprising fiber-reinforced reinforcing components. Details corresponding to the components explained above with reference to the embodiment according to FIG. 1 are given the same reference labels and are not discussed further in detail.

Sash frame profile 1 according to FIG. 2 has a total of four inner reinforcing components 39, 40, 41, 42, which are numbered consecutively from left to right in FIG. 2, i.e. from the outside to the inside.

The inner reinforcing component 39 runs spaced apart from the un-reinforced outer wall 4 in the embodiment according to FIG. 2. The inner reinforcing component 39 represents a boundary wall for hollow spaces 9, 10, 11 and 21. These hollow spaces 9, 10, 11, 21 are also delimited in the embodiment according to FIG. 2 by the un-reinforced outer wall 4, the un-reinforced boundary walls 12 and by the un-reinforced rabbet base wall 13 and in the case of the embodiment according to FIG. 2 by the un-reinforced folded fitting wall 6.

The inner reinforcing component 40 runs at a distance to the inner reinforcing component parallel to the outer wall 4 between the rabbet base wall 13 and the folded fitting wall 6. The inner reinforcing component 40 represents a boundary wall for hollow spaces 21 and 22. Hollow space 22 is also delimited by the un-reinforced rabbet base wall 13, the un-reinforced folded fitting wall 6 and the inner reinforcing component 41. The inner reinforcing component comprises two ribs at a distance, and is angled in sections proximate to said ribs, which increases the stability of the inner reinforcing component 40. Inner reinforcing component 41 also comprises such ribs, which increase the stability of the component.

Inner reinforcing component 41 runs parallel to inner reinforcing component 40, likewise between the rabbet base wall 13 and the folded fitting wall 6, and also delimits hollow space 23. This is likewise delimited by the un-reinforced rabbet base wall 13, the un-reinforced boundary wall 12 and by the un-reinforced folded fitting wall 6 and finally by inner reinforcing component 42.

The latter runs parallel to and at a distance from the un-reinforced inner wall 5 in the case of the embodiment according to FIG. 2. Inner reinforcing component 42 delimits hollow space 16 in addition to hollow space 23. Hollow space 16 is also delimited by un-reinforced inner wall 5, un-reinforced rabbet base wall 13 and un-reinforced boundary wall 12.

The window/door frame profile 2 according to FIG. 2 also comprises four inner reinforcing components 43, 44, 45, 46, which are numbered consecutively from outside to inside in FIG. 2.

Inner reinforcing component 43 runs at an angle to un-reinforced outer wall 25 at a distance thereto in the case of the embodiment according to FIG. 2. Inner reinforcing component 43 delimits hollow spaces 29, 30 and another hollow space 47 of window/door frame profile 2. Hollow spaces 29 and 30 are also delimited by un-reinforced boundary walls 31 and by un-reinforced outer wall 25. Hollow space 47 is also delimited by folded fitting wall 32, attachment wall 33 and by inner reinforcing component 44.

The latter reinforcing component runs at a distance to reinforcing component 43 likewise between folded fitting wall 32 and attachment wall 33. Inner reinforcing component 44 also delimits a central hollow space 48 of the window/door frame profile 2 in addition to delimited hollow space 47. The central hollow space is also delimited by un-reinforced folded fitting wall 32, un-reinforced attachment wall 33 and by inner reinforcing component 45.

The latter reinforcing component runs between folded fitting wall 32 and attachment wall 33 at a distance to un-reinforced inner wall 34 in the case of the embodiment according to FIG. 2. Inner reinforcing component 45 also comprises a stability increasing rib. Inner reinforcing component 45 delimits other hollow spaces 49 and 50 in addition to hollow space 48. These hollow spaces are also delimited by un-reinforced boundary wall 31, un-reinforced folded fitting wall 32 and un-reinforced attachment wall 33 and by inner reinforcing component 46.

This component runs between inner reinforcing component 45 and inner wall 34 and parallel to these two walls. Inner reinforcing component 46 delimits hollow spaces 37, 38, 49 and 50. Hollow spaces 37 and 38 are also delimited by un-reinforced boundary wall 31, un-reinforced folded fitting wall 32, un-reinforced attachment wall 33 and by un-reinforced inner wall 34.

Reinforcing components 43 through 46 on one side and 47 through 50 on the other side run substantially parallel to one another and are not connected together. Inner reinforcing components 39 and 46 intersect with un-reinforced boundary walls 12 and 31. Inner reinforcing components 43 and 45 form a T-configuration with inner un-reinforced boundary walls 31. Inner reinforcing components 40, 41, 42, and 44 represent reinforcing walls that run freely between boundary walls of the frame profiles 1, 2.

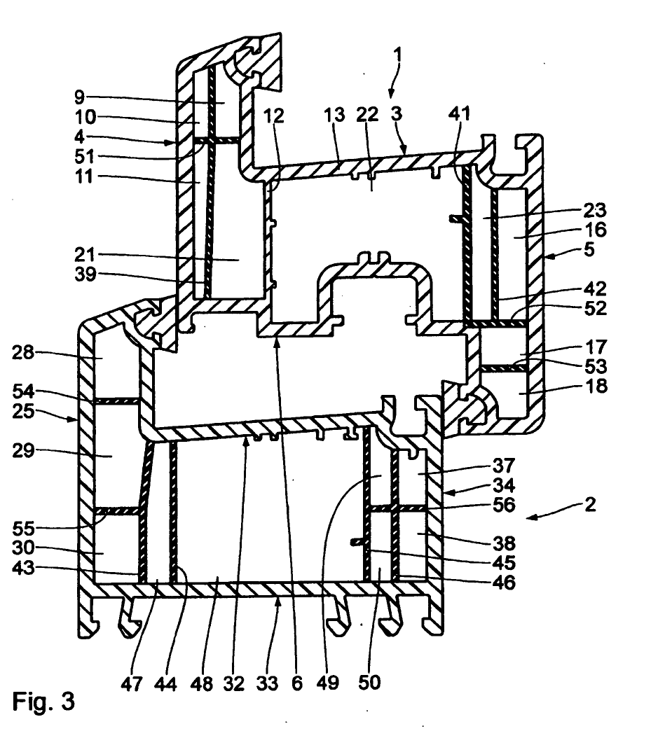

In the embodiment according to FIG. 3, the sash frame profile comprises inner reinforcing components 39, 41 and 42. In addition, sash frame profile 1 according to FIG. 3 comprises a reinforcing component 51 that runs substantially perpendicular to inner reinforcing component 39 and intersects the same. Inner reinforcing component 51 delimits hollow spaces 9, 10, 11 and 21. Together with inner reinforcing component 39, inner reinforcing component 51 forms a structure that is in the shape of a cross in cross section so that an overall reinforcing component 39, 51 results which is angled in areas, having a three-dimensional, i.e. non-planar, structure.

Also, the sash frame profile 1 according to FIG. 3 comprises two more inner reinforcing components 52 and 53. Inner reinforcing component 52 delimits hollow spaces 16, 17 and 23 and runs beneath inner reinforcing components 41, 42 and perpendicular thereto, wherein reinforcing component 52 connects the two inner reinforcing components 41 and 42 together on one side and connects un-reinforced folded fitting wall 6 and un-reinforced inner wall 5 together on the other side. This forms an overall reinforcing component 41, 42, 52 that has a three-dimensional structure of increased stability, i.e. that is angled in areas. Inner reinforcing component 53 delimits hollow spaces 17 and 18. Inner reinforcing component 53 runs freely between folded fitting wall 6 and inner wall 5.

In addition to inner reinforcing components 43 through 46, the window/door frame profile 2 according to FIG. 3 further comprises other inner reinforcing components 54 through 56 that run substantially perpendicular thereto. Inner reinforcing component 54 runs freely between outer wall 25 and folded fitting wall 32 and delimits hollow spaces 28 and 29. Inner reinforcing component 55 runs between outer wall 25 and inner reinforcing component 43 and delimits hollow spaces 29 and 30.

Inner reinforcing component 55 forms an overall reinforcing component 43, 55 together with inner reinforcing component 43, said overall reinforcing component having a three-dimensional overall structure, i.e. is non-planar and thus is designed so as to be angled in areas. Inner reinforcing component 56 runs between un-reinforced inner wall 34 and inner reinforcing component 45 and intersects inner reinforcing component 46. Inner reinforcing components 45, 46, 56 form an overall reinforcing component that has a three-dimensional structure for increased stability, and that is angled in areas. Inner reinforcing component 56 delimits hollow spaces 37, 38, 49 and 50.

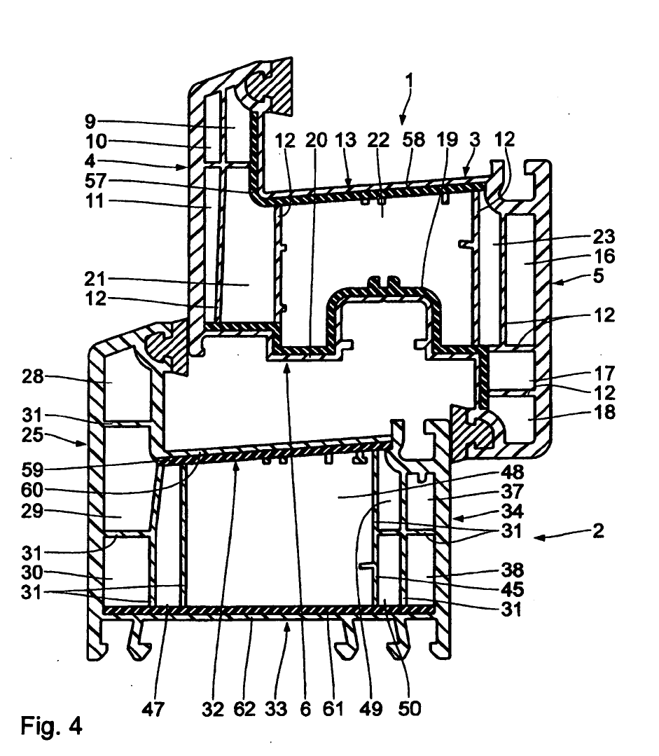

In the embodiment of the sash frame profile 1 according to FIG. 4, a rabbet base wall reinforcing component 57 is embedded into rabbet base wall 13. Rabbet base wall reinforcing component 57 substantially follows the contour of rabbet base wall 13 in curved fashion. Rabbet base wall reinforcing component 57 is covered toward the rabbet base by a rabbet base wall cover layer 58. Rabbet base wall reinforcing component 57 delimits hollow spaces 9, 21, 22 and 23.

Sash frame profile 1 according to FIG. 4 further comprises folded fitting cover layer 20. In the embodiment according to FIG. 4, folded fitting cover layer 20 delimits hollow spaces 11, 21, 22, 23, 17 and 18. The two reinforcing components 19 and 57 of sash frame profile 1 according to FIG. 4 are not connected together.

In the embodiment according to FIG. 4, window/door frame profile 2 comprises a folded fitting reinforcing component 59 that is embedded into folded fitting wall 32. Folded fitting reinforcing component 59 is covered toward the folded fitting by a folded fitting cover layer 60 made of non-reinforced material. Folded fitting reinforcing component 59 follows the contour of the base of folded fitting wall 32. Folded fitting reinforcing component 59 delimits hollow spaces 47, 48 and 49.

Window/door frame profile 2 according to FIG. 4 further comprises an attachment wall reinforcing component 61 that follows the contour of attachment wall 33. Attachment wall reinforcing component 61 is covered downward, i.e. toward the brick structure for example, by an attachment wall cover layer 62 made of non-reinforced material. Attachment wall reinforcing component 61 delimits hollow spaces 30, 47, 48, 50 and 38.

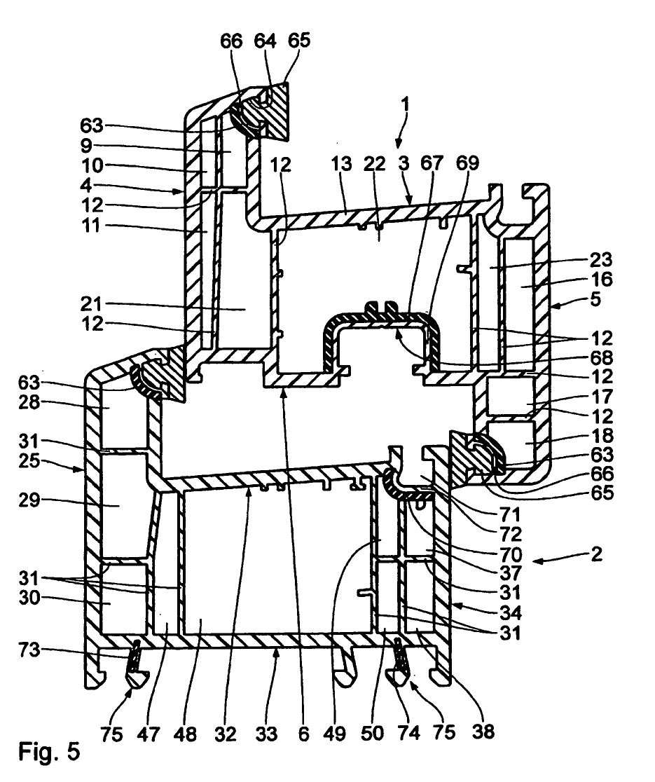

Sash frame profile 1 according to FIG. 5 comprises a seal seat reinforcing component 63 proximate to a rest seat 64 for a sealing lip 65 of sash frame profiles 1, said seal seat reinforcing component being bent as seen in cross section. The seal seat reinforcing component 63 is covered to the rest seat 64 by a seal seat cover layer 66. The seal seat reinforcing component 63 delimits hollow space 9.

Sash frame profile 1 further comprises a folded fitting sectional reinforcing component 67 that is embedded in a groove section 68 of folded fitting wall 6. Folded fitting sectional reinforcing component 67 is curved in the shape of a U in cross section and comprises two stabilizing ribs. A groove section cover layer 69 covers the folded fitting sectional reinforcing component 67 toward the folded fitting. Folded fitting sectional reinforcing component 67 delimits central hollow space 22 of the sash frame profile 1. Folded fitting sectional reinforcing component 67 has a substantially U-shaped base contour.

Sash frame profile 1 according to FIG. 5 comprises another seal seat reinforcing component 63 proximate to another seal seat cover layer 66 for another sealing lip 65, wherein said reinforcing component 63 has a design that corresponds to the seal seat reinforcing component 63 already described above. This other seal seat reinforcing component 63 of sash frame profile 1 delimits hollow space 18.

Window/door frame profile 2 also comprises a seal seat reinforcing component 63 having a design corresponding to the seal seat reinforcing component 63 already described above in connection with sash frame profile 1. This seal seat reinforcing component 63 of window/door frame profile 2 delimits hollow space 28. window/door frame profile 2 according to FIG. 5 further comprises a folded fitting sectional reinforcing component 70 that has a curved cross section and that is embedded in a groove section 71 of folded fitting wall 32 of window/door frame profile 2. Folded fitting reinforcing component 70 is covered to the folded fitting by a groove section cover layer 72. This folded fitting sectional reinforcing component 70 delimits hollow spaces 37 and 49.

Window/door frame profile 2 according to FIG. 5 further comprises two attachment webs 75 reinforced with web reinforcing components 73, 74, said attachment webs being molded onto the attachment wall 33. Attachment webs 75 facilitate the attachment of the window/door frame profile 2, for example to the brick structure.

Frame profiles 1, 2 of the embodiments described above represent co-extrudates comprising the respective reinforcing components and un-reinforced boundary walls. Prior to extrusion, fibers are added to the plastic material that is plasticized in the extruder during extrusion of the reinforcing components; these fibers therefore form a plastic mass that can flow together with the plastic matrix during extrusion of the reinforcing components.

The frame profiles 1, 2 are made of glass-fiber reinforced and otherwise un-reinforced high-impact strength PVC in the area of the reinforcing components.

This PVC has a K value describing its flow characteristics, i.e. its melt viscosity in particular, of between 50 and 60. This K value can be converted to intrinsic viscosity of the PVC using the following relationship:

[η]=2.303×(75 k²+k) with K value=1000 k

The profile elements have a glass fiber fraction of at most 25 wt.-%, preferably at most 20 wt.-%, more preferably at most 15 wt.-%, with a length of the individual glass fibers of between 1 and 3 mm.

The cover layers can be made of a different non-fibrous, high impact strength plastic material, including for example PBT (polybutylene terephthalate). Alternatively, the cover layers can also be made of ASA (acrylonitrile-styrene-acrylic ester) or SB (styrene-butadiene).

Alternative materials for the fiber-reinforced profile frames include ABS (acrylonitrile/butadiene/styrene), ASA (acrylonitrile/styrene/acrylic ester) and SB (styrene/butadiene). These copolymers are well suited for fiber-reinforcement and for tailoring the coefficients of thermal expansion of the profile frame to match the coefficients of thermal expansion of the glass panes of an insulating glazing.

The fiber reinforcement of the fiber-reinforced components of the profile frame, i.e. the reinforcing components thereof, can also be done using organic polymer-based fibers, in particular PAN (polyacrylonitrile), as an alternative to glass fibers. It is also possible to use a higher fiber fraction than 15 or 20 wt.-% with such fibers. Despite this higher fiber fraction, the material remains easily welded. In the embodiments of the reinforcing components illustrated, the fibers have a maximum length of 10 mm. Embodiments are also possible with a maximum fiber length of 5 mm.

1. A frame assembly comprising a surface bearing element with at least one glass pane, a plastic profile frame enclosing the end face of the surface hearing element. said plastic profile frame having reinforcing components made of fiber-reinforced plastic for providing reinforcement, a receiving portion for a an enclosing edge portion of the surface bearing clement, characterized in that the reinforcing components made of fiber-reinforced plastic represent boundary walls of inner hollow spaces of the profile frame, said boundary walls that, together with un-reinforced boundary walls delimit the internal hollow spaces, the profile frame being embodied as a coextrudate of the reinforcing components and the un-reinforced boundary walls, wherein the reinforcing components are designed to be exposed to the hollow spaces where they delimit the inner hollow spaces.

2. Frame assembly according to claim 1, wherein a reinforcing component is made of fiber-reinforced plastic in an outer wall of the profile frame.

3. Frame assembly according to claim 1, wherein a reinforcing component is made of fiber-reinforced plastic in an inner wall of the profile frame.

4. Frame assembly according to claim 1, wherein a reinforcing component is made of fiber-reinforced plastic in a folded fitting wall of the profile frame.

5. A frame assembly according to claim 1, wherein the reinforcing component has a substantially U-shaped base contour in cross section.

6. Frame assembly according to claim 1, wherein a reinforcing component is designed as an inner wall of the profile frame.

7. Frame assembly according to claim 1, wherein a reinforcing component is made of fiber-reinforced plastic in an attachment wall of the profile frame.

8. Frame assembly according to claim 1, wherein a reinforcing component is made of fiber-reinforced plastic in a sealing or rest seat of the profile frame.

9. Frame assembly according to claim 1, wherein at least one of the reinforcing components is designed at least in sections as bent and/or angled in a cross section perpendicular to the direction of extrusion.

10. Frame assembly according to claim 1, wherein the reinforcing components comprise fibers with a maximum length of 10 mm, preferably with a maximum length of 5 mm.

11. Plastic profile frame comprising at least one reinforcing component for constructing a frame assembly according to claim 1.

12. Plastic profile frame according to claim 11, designed as a sash frame.

13. Plastic profile frame according to claim 11, designed as a window/door frame for holding a sash frame.

14. Frame profile for a plastic profile frame according to claim 12.

15. Frame assembly according to claim 2, wherein a reinforcing component is made of fiber-reinforced plastic in an inner wall of the profile frame.

16. Frame assembly according to claim 15, wherein a reinforcing component is made of fiber-reinforced plastic in an inner wall of the profile frame.

17. Frame assembly according to claim 2, wherein a reinforcing component is made of fiber-reinforced plastic in a fielded fitting wall of the profile frame.

18. Frame assembly according to claim 3, wherein a reinforcing component is made of fiber-reinforced plastic in a folded titling wall of the profile frame.

19. A frame assembly according to claim 2, wherein the reinforcing component has a substantially U-shaped base contour in cross section.

20. A frame assembly according to claim 3, wherein the reinforcing component has a substantially U-shaped base contour in cross section.
